(19) United States
(12) Patent Application Publication
(10) Pub. No.: US 2006/0268014 A1
(43) Pub. Date: Nov. 30, 2006

(54) System and method for efficiently supporting image deformation procedures in an electronic device

(76) Inventors: Jiliang Song, Surrey (CA); John Peter van Baarsen, Delta (CA)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 11/139,839

(22) Filed: May 27, 2005

(51) Int. Cl. G09G 5/00

(52) U.S. Cl. 345/647; 345/619

(57) ABSTRACT

A system and method for efficiently supporting image deformation procedures in an electronic device includes a deformation lookup table that stores deformation values for performing an image deformation procedure. A deformation module coupled to the electronic device includes a pixel calculator that references the deformation values from the deformation lookup table to calculate source pixel locations of source pixels in an original image for populating destination pixels in a deformed image.

### BACKGROUND SECTION

1. Field of Invention

This invention relates generally to electronic display controller systems, and relates more particularly to a system and method for efficiently supporting image deformation procedures in an electronic device.

2. Description of the Background Art

Implementing efficient methods for displaying electronic image data is a significant consideration for designers and manufacturers of contemporary electronic devices. However, efficiently displaying image data with electronic devices may create substantial challenges for system designers. For example, enhanced demands for increased device functionality and performance may require more system operating power and require additional hardware resources. An increase in power or hardware requirements may also result in a corresponding detrimental economic impact due to increased production costs and operational inefficiencies.

Furthermore, enhanced device capability to perform various advanced display operations may provide additional benefits to a system user, but may also place increased demands on the control and management of various device components. For example, an enhanced electronic device that efficiently manipulates, transfers, and displays digital image data may benefit from an efficient implementation because of the large amount and complexity of the digital data involved.

Due to growing demands on system resources and substantially increasing data magnitudes, it is apparent that developing new techniques for controlling the display of electronic image data is a matter of concern for related electronic technologies. Therefore, for all the foregoing reasons, developing efficient systems for displaying electronic image data remains a significant consideration for designers, manufacturers, and users of contemporary electronic devices.

### SUMMARY

In accordance with the present invention, a system and method are disclosed for efficiently supporting image deformation procedures in an electronic device. In certain embodiments, the electronic device may be implemented to include a central-processing unit (CPU), a display, and a display controller with a deformation module.

In one embodiment, image data from an original image is initially stored in a line/frame buffer of the deformation module. The deformation module may then calculate source pixels from the original image for populating destination pixels from a deformed image. A pixel calculator, under control of control logic of the deformation module, calculates x′ and y′ coordinates of the source pixels in the original image by referencing pre-calculated deformation values in a deformation lookup table. The pixel calculator may utilize recursive pixel-location equations to calculate the coordinates of the source pixels in the original image.

In certain embodiments, the recursive pixel-location equations need only be utilized to calculate the source pixel that corresponds to a top left destination pixel in the deformed image. After the source pixel corresponding to the top left destination pixel is determined, an offset value and a sequential addition procedure may efficiently be utilized to locate all remaining source pixels in the original image for populating the deformed image.

A pixel fetch module of the deformation module, under control of the control logic, may then utilize the calculated x′ and y′ coordinates to locate appropriate source pixels in the original image for populating corresponding destination pixels in a deformed image. An interpolation module of the deformation module may utilize the identified x′ and y′ coordinates of the source pixels for performing a interpolation procedure with neighboring pixels from the original image to produce final destination pixels for the deformed image.

The present invention may be utilized to support any appropriate deformation effects by implementing the recursive pixel-location equations with corresponding deformation lookup tables. Such deformation effects may include perspective, zoom, dewarping, wave effects, or any other type of deformation effect. The present invention provides an effective recursive method to support different image deformation effects with the same compact hardware in a display controller. For at least the foregoing reasons, the present invention provides an improved system and method for efficiently supporting image deformation procedures in an electronic device.

### BRIEF DESCRIPTION OF THE DRAWINGS

FIG. 1 is a block diagram for one embodiment of an electronic device, in accordance with the present invention;

FIG. 2 is a block diagram for one embodiment of the display controller of FIG. 1, in accordance with the present invention;

FIG. 3 is a block diagram for one embodiment of the video memory of FIG. 2, in accordance with the present invention;

FIG. 4 is a block diagram for one embodiment of the controller registers of FIG. 2, in accordance with the present invention;

FIG. 5 is a block diagram for one embodiment of the display of FIG. 1, in accordance with the present invention;

FIG. 6 is a diagram illustrating one exemplary embodiment of an original image and a corresponding deformed image, in accordance with the present invention;

FIG. 7 is a diagram illustrating one exemplary embodiment of an original image and a corresponding deformed image, in accordance with the present invention;

FIG. 8 is a block diagram for one embodiment of the deformation module of FIG. 2, in accordance with the present invention;

FIG. 9 is a block diagram for one embodiment of the pixel calculator of FIG. 8, in accordance with the present invention;

FIG. 10 is a diagram illustrating one exemplary embodiment of a horizontal 2× zoom deformation, in accordance with the present invention;

FIG. 11 is a diagram illustrating one exemplary embodiment of a dewarped image, in accordance with the present invention; and

FIG. 12 is a diagram illustrating one exemplary embodiment of a horizontal perspective deformation, in accordance with the present invention.

### DETAILED DESCRIPTION

The present invention relates to an improvement in display controller systems. The following description is presented to enable one of ordinary skill in the art to make and use the invention, and is provided in the context of a patent application and its requirements. Various modifications to the embodiments disclosed herein will be apparent to those skilled in the art, and the generic principles herein may be applied to other embodiments. Thus, the present invention is not intended to be limited to the embodiments shown, but is to be accorded the widest scope consistent with the principles and features described herein.

The present invention comprises a system and method for efficiently supporting image deformation procedures in an electronic device, and includes a deformation lookup table that stores deformation values for performing an image deformation procedure. A deformation module coupled to the electronic device includes a pixel calculator that references the deformation values from the deformation lookup table to calculate source pixel locations of source pixels in an original image for populating destination pixels in a deformed image.

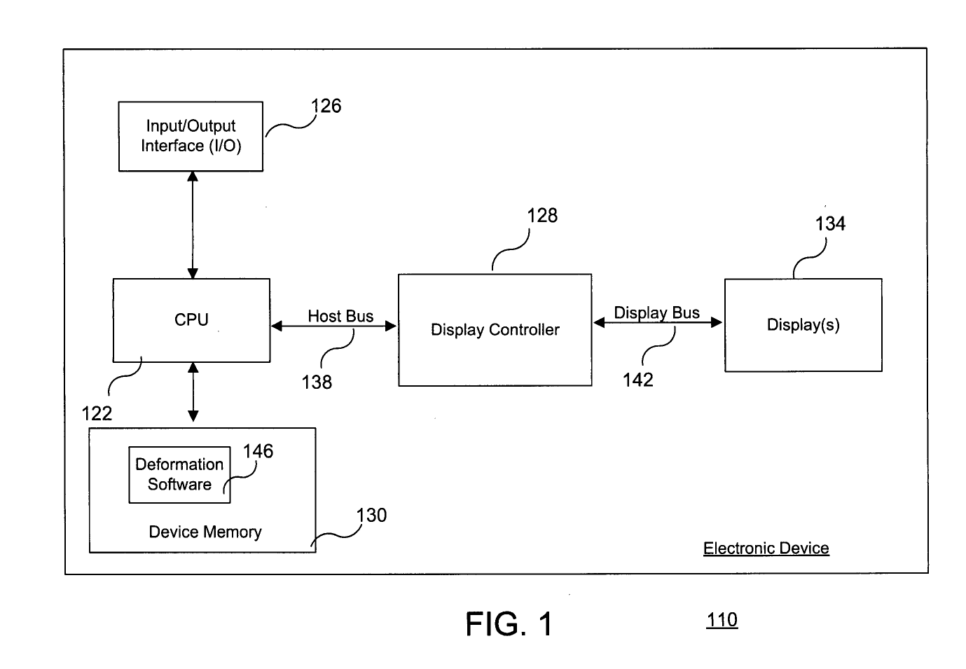

Referring now to FIG. 1, a block diagram for one embodiment of an electronic device 110 is shown, according to the present invention. The FIG. 1 embodiment includes, but is not limited to, a central processing unit (CPU) 122, an input/output interface (I/O) 126, a display controller 128, a device memory 130, and one or more display(s) 134. In alternate embodiments, electronic device 110 may include elements or functionalities in addition to, or instead of, certain of the elements or functionalities discussed in conjunction with the FIG. 1 embodiment.

In the FIG. 1 embodiment, CPU 122 may be implemented as any appropriate and effective processor device or microprocessor to thereby control and coordinate the operation of electronic device 110 in response to various software program instructions. In the FIG. 1 embodiment, device memory 130 may comprise any desired storage-device configurations, including, but not limited to, random access memory (RAM), read-only memory (ROM), and storage devices such as removable memory or hard disk drives. In the FIG. 1 embodiment, device memory 130 may include, but is not limited to, deformation software 146 with program instructions that are executed by CPU 122 to support various deformation procedures for electronic device 110.

In the FIG. 1 embodiment, the a device application (not shown) may include program instructions for allowing CPU 122 to provide image data and corresponding transfer and display information via host bus 138 to display controller 128. In accordance with the present invention, display controller 128 then responsively provides the received image data via display bus 142 to at least one of the display(s) 134 of electronic device 110. In the FIG. 1 embodiment, input/output interface (I/O) 126 may include one or more interfaces to receive and/or transmit any required types of information to or from electronic device 110. Input/output interface 126 may include one or more means for allowing a device user to communicate with electronic device 110. In addition, various external electronic devices may communicate with electronic device 110 through I/O 126. For example, a digital imaging device, such as a digital camera, may utilize input/output interface 126 to provide captured image data to electronic device 110.

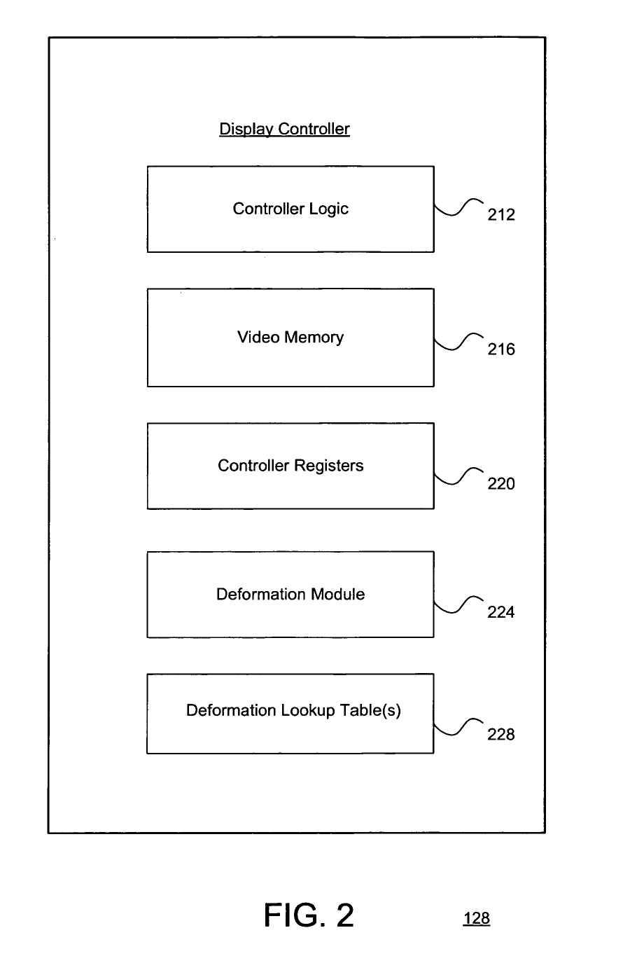

In the FIG. 1 embodiment, electronic device 110 may advantageously utilize display controller 128 for efficiently managing various operations and functionalities relating to display(s) 134. The implementation and functionality of display controller 128 is further discussed below in conjunction with FIGS. 2-4 and 6-12. In the FIG. 1 embodiment, electronic device 110 may be implemented as any desired type of electronic device or system. For example, in certain embodiments, electronic device 110 may alternately be implemented as a cellular telephone, a personal digital assistant device, an electronic imaging device, or a computer device. Various embodiments for the operation and utilization of electronic device 110 are further discussed below in conjunction with FIGS. 2-12.

Referring now to FIG. 2, a block diagram for one embodiment of the FIG. 1 display controller 128 is shown, in accordance with the present invention. The FIG. 2 embodiment includes, but is not limited to, controller logic 212, video memory 216, controller registers 220, a deformation module 224, and one or more deformation lookup tables 228. In alternate embodiments, display controller 128 may include elements or functionalities in addition to, or instead of, certain of the elements or functionalities discussed in conjunction with the FIG. 2 embodiment.

In the FIG. 2 embodiment, display controller 128 may be implemented as an integrated circuit device that accepts image data and corresponding transfer and display information from CPU 122 (FIG. 1). Display controller 128 then automatically provides the received image data to display 134 of electronic device 110 in an appropriate and efficient manner for displaying to a device user. In the FIG. 2 embodiment, controller logic 212 manages and coordinates the overall operation of display controller 128.

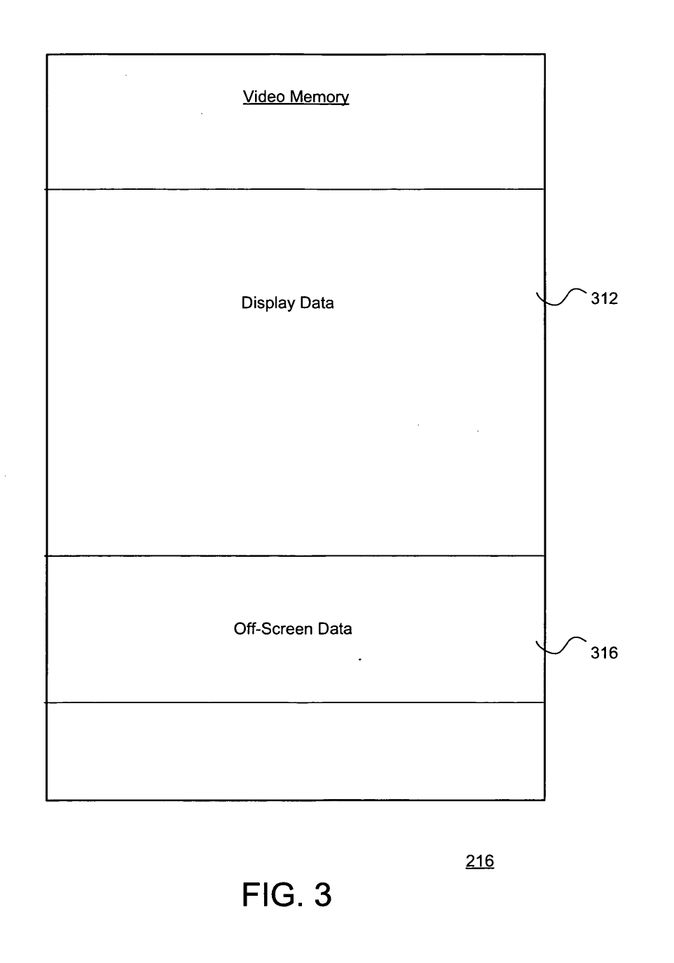

In the FIG. 2 embodiment, display controller 128 may utilize controller registers 220 to store various types of configuration, control and status information. In the FIG. 2 embodiment, display controller 128 may utilize deformation module 224 and deformation lookup table(s) 228 to efficiently perform various image deformation procedures. In the FIG. 2 embodiment, CPU 122 may execute program instructions from deformation software 146 (FIG. 1) to calculate various values for populating deformation lookup table(s) 228. The utilization of display controller is further discussed below in conjunction with FIGS. 3-12.

Referring now to FIG. 3, a block diagram for one embodiment of the FIG. 2 video memory 216 is shown, in accordance with the present invention. In the FIG. 3 embodiment, video memory 216 includes, but is not limited to, display data 312 and off-screen data 316. In alternate embodiments, video memory 216 may include elements and functionalities in addition to, or instead of, certain of the elements and functionalities discussed in conjunction with the FIG. 3 embodiment.

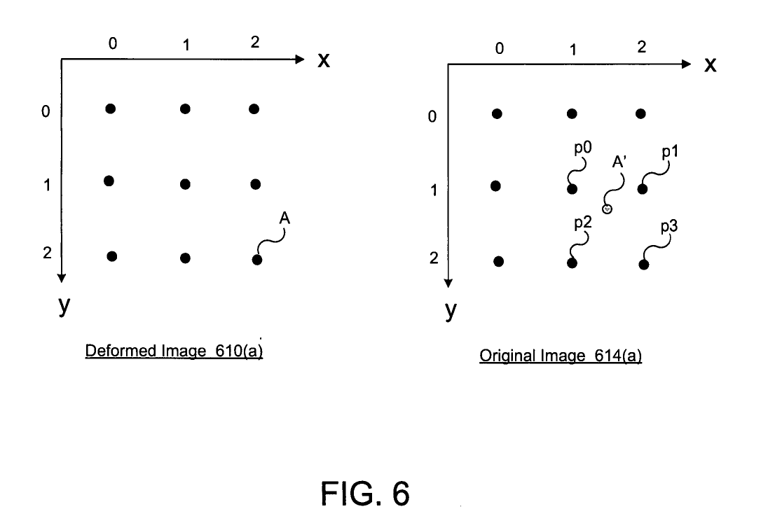

In the FIG. 3 embodiment, video memory 216 may be implemented by utilizing any effective types of memory devices or configurations. For example, in certain embodiments, video memory 216 may be implemented as a random-access memory (RAM) device. In the FIG. 3 embodiment, display data 312 may include original images that are provided by CPU 122 or other appropriate source. In accordance with the present invention, display data 312 may also include deformed images produced by deformation module 224 (FIG. 2) from the original images. In the FIG. 3 embodiment, off-screen data 316 may include any appropriate type of information or data that is not intended for presentation upon display 134 of electronic device 110. For example, off-screen data 316 may be utilized to cache certain fonts or other objects for use by display controller 128. The generation of deformed images is further discussed below in conjunction with FIGS. 6-12.

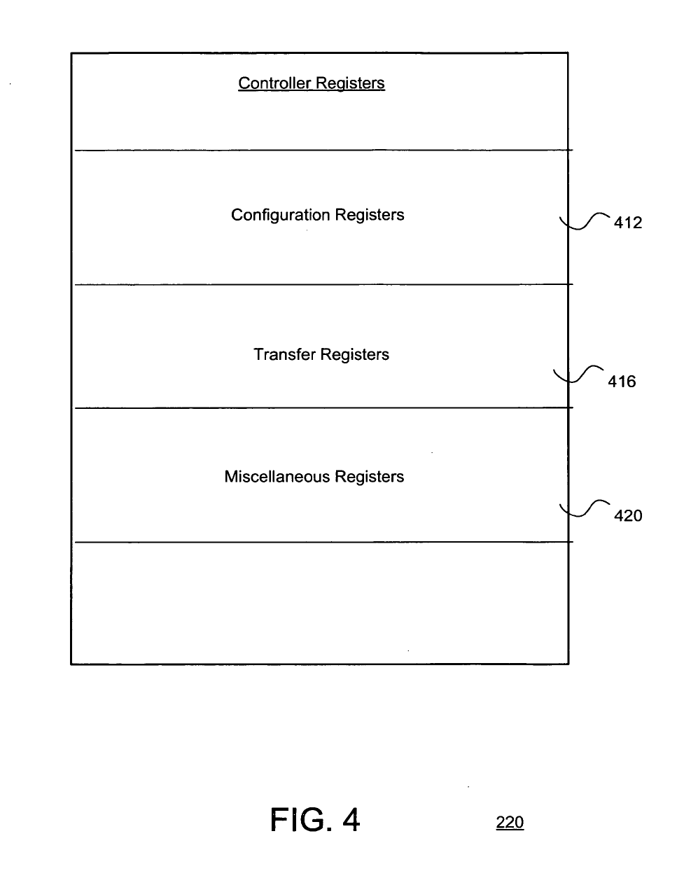

Referring now to FIG. 4, a block diagram for one embodiment of the FIG. 2 controller registers 220 is shown, in accordance with the present invention. In the FIG. 4 embodiment, controller registers 220 include, but are not limited to, configuration registers 412, transfer registers 416, and miscellaneous registers 420. In alternate embodiments, controller registers 220 may include elements and functionalities in addition to, or instead of, certain of the elements and functionalities discussed in conjunction with the FIG. 4 embodiment.

In the FIG. 4 embodiment, CPU 122 (FIG. 1) or other appropriate entities may write information into controller registers 220 to specify various types of operational parameters and other relevant information for use by configuration logic 212 of display controller 128. In the FIG. 4 embodiment, controller registers 220 may utilize configuration registers 412 for storing various types of information relating to the configuration of display controller 128 and/or display 134 of electronic device 110. For example, configuration registers 220 may specify a display type, a display size, a display frame rate, and various display timing parameters. In the FIG. 4 embodiment, controller registers 220 may utilize transfer registers 416 for storing various types of information relating to transfer operations for providing pixel data from video memory 216 (FIG. 3) to display 134 of electronic device 110. In the FIG. 4 embodiment, controller registers 220 may utilize miscellaneous registers 420 for effectively storing any desired type of information or data for use by display controller 128.

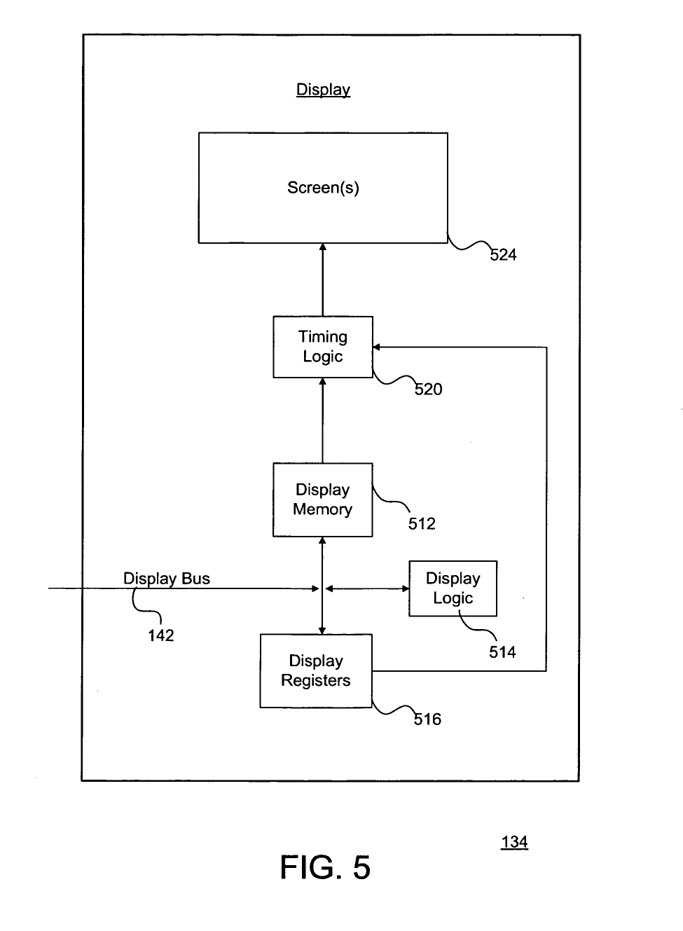

Referring now to FIG. 5, a block diagram for one embodiment of the FIG. 1 display 134 is shown, in accordance with the present invention. In the FIG. 5 embodiment, display 134 includes, but is not limited to, a display memory 512, display logic 514, display registers 516, timing logic 520, and one or more screen(s) 524. In alternate embodiments, display 134 may include elements and functionalities in addition to, or instead of, certain of the elements and functionalities discussed in conjunction with the FIG. 5 embodiment.

In the FIG. 5 embodiment, display 134 is implemented as a random-access-memory based liquid-crystal display panel (RAM-based LCD panel). However, in alternate embodiments, display 134 may be implemented by utilizing any type of appropriate display technologies or configurations. In the FIG. 5 embodiment, display controller 128 provides various types of display information to display registers 516 via display bus 142. Display registers 516 may then utilize the received display information for effectively controlling timing logic 520. In the FIG. 5 embodiment, display logic 514 manages and coordinates data transfer and display functions for display 134.

In the FIG. 5 embodiment, display controller 128 provides image data from video memory 216 (FIG. 2) to display memory 512 via display bus 142. In the FIG. 5 embodiment, display memory 512 is typically implemented as random-access memory (RAM). However, in various other embodiments, any effective types or configurations of memory devices may be utilized to implement display memory 512. In the FIG. 5 embodiment, display memory 512 then advantageously provides the image data received from display controller 128 to one or more screens 524 via timing logic 520 for viewing by a device user of electronic device 110.

Referring now to FIG. 6, a diagram illustrating one exemplary embodiment of an original image 614(a) and a corresponding deformed image 610(a) is shown, in accordance with the present invention. The example shown in FIG. 6 is presented for purposes of illustration, and in alternate embodiments, the present invention may efficiently support deformation procedures by utilizing configurations and techniques in addition to, or instead of, certain of those configurations and techniques shown in the FIG. 6 embodiment.

The present invention provides a recursive system and method to support different real-time image deformations with a single compact hardware implementation. These deformations may apply various different effects to the original image. The deformation procedures may include any appropriate techniques, including a dewarping deformation, a wave deformation, a zoom in/out deformation, and a perspective deformation. In certain embodiments, the present invention may be effectively utilized to perform dewarping procedures to compensate for lens distortions in an image capture device.

In accordance with the present invention, in order to obtain the appropriate color data for each pixel in a deformed image 610(a), the deformation procedure includes, but is not limited to, two main steps:
Step 1. The display controller 128 initially locates the position of a source pixel A′(x′, y′) in the original image 614(a) for populating a corresponding destination pixel A(x,y) in the deformed image 610(a). The x and y values represent the x-coordinate and y-coordinate for a destination pixel A in the deformed image 610(a). Both x and y coordinates are typically integers.
Step 2. Display controller 128 then chooses one source pixel from the position (x′, y′) in the original image 614(a) as the color data for the destination pixel A(x,y). Normally, the x′ and y′ coordinates are not integers. Therefore, some type of interpolation or other appropriate procedure may be effectively utilized.

For instance, in the FIG. 6 example, display controller 128 first locates the source pixel A′ in original image 614(a) that corresponds to destination pixel A(2, 2) of deformed image 610(a). If the destination pixel A(2, 2) of deformed image 610(a) is mapped to source pixel A′(1.5, 1.2) of original image 614(a), then display controller 128 may then calculate the specific data for destination pixel A from the four neighboring pixels of source pixel A′, p0(1, 1), p1(2, 1), p2(2, 1), and p3(2, 2), by using bilinear interpolation or other appropriate techniques.

The specific implementation for foregoing interpolation step 2 may utilize any effective methodologies or procedures. For example, the FIG. 6 embodiment may utilize a bilinear interpolation procedure or a bicubic interpolation procedure. The foregoing interpolation procedures are known processes, and may be the same or similar for any of the various deformation effects supported by the present invention.

The techniques utilized for the foregoing step 1 for finding the position of original pixels A′(x′, y′), typically depend on the type of deformation effect that is being supported. Certain deformation effects require a substantial number of calculations. These calculations may be performed by software, software plus a lookup table, or hardware. Software alone tends to be too slow to effectively deform the real-time images, especially in environments such as video streaming.

When utilizing software plus a lookup table for a specified deformation effect, the calculations need only be performed once. Software may therefore calculate these source pixel positions for the 1st video frame and store these source pixel positions into a local memory. The following frames do not require additional calculations, because display controller 128 may read the source pixel positions from the local memory. However, in certain embodiments, the memory required may be extensive. For example, to support a 1280 pixel×1024 pixel image, both the x′ coordinate and the y′ coordinate require 16-bits (2 bytes), so one pixel requires 4 bytes to store its (x′, y′) coordinate data. The entire frame therefore requires 1280×1024×4=5.12 MBytes of memory.

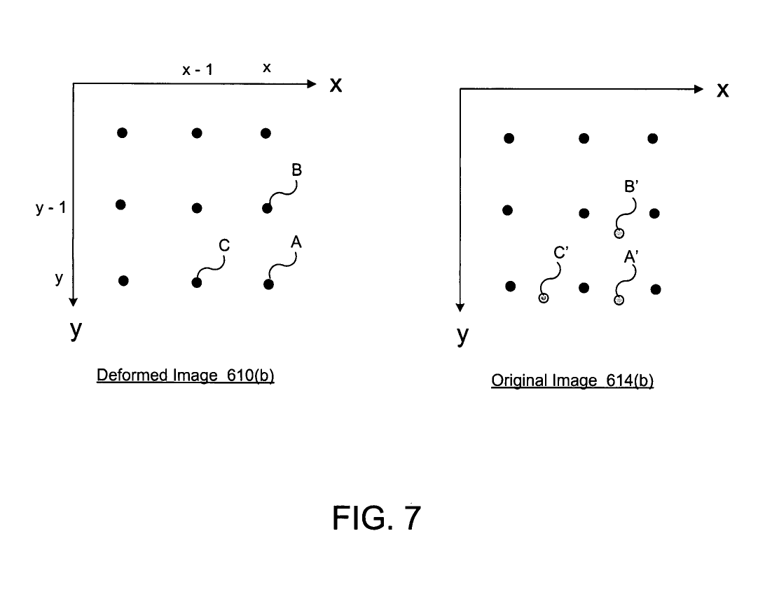

A hardware implementation may be effectively utilized to meet real-time requirements. However, the logic size may be very large because different deformation effects each require different calculations, and these calculations may require a substantial number of dividers and multipliers. As discussed below in conjunction with FIGS. 7-12, the present invention advantageously provides a system and method to efficiently implement the foregoing calculations with relatively simple hardware in conjunction with a small lookup table for each of the different supported deformation effects.

Referring now to FIG. 7, a diagram illustrating one exemplary embodiment of an original image 614(b) and a corresponding deformed image 610(b) is shown, in accordance with the present invention. The example shown in FIG. 7 is presented for purposes of illustration, and in alternate embodiments, the present invention may efficiently support deformation procedures by utilizing configurations and techniques in addition to, or instead of, certain of those configurations and techniques shown in the FIG. 7 embodiment.

In the FIG. 7 example, display controller 128 performs certain calculations with a recursive algorithm to calculate source pixels from original image 614(b) for populating the destination pixels in deformed image 610(b). In accordance with the FIG. 7 embodiment, the x′ and y′ coordinates of source pixels from original image 614(b) are functions of the x and y coordinates of corresponding destination pixels from deformed image 610(b), depending upon the type of deformation effect in question.

Therefore, the foregoing relationship between source pixels and destination pixels may be expressed by the following formulas:
x′=fₓ(x, y)
y′=f_{y}(x, y)
where 0<=x<HDP, and 0<=y<VDP. HDP may be defined as the horizontal size of a supported image, and VDP may be defined as the vertical size of the same display image.

Different deformation effects may require different functions, fₓ and f_{y}. In accordance with the FIG. 7 embodiment, to implement the foregoing different functions with the same hardware, functions fₓ and f_{y} are rewritten. If the position B′ in original image 614(b) corresponding to the destination pixel B(x, y−1) of deformed image 610(b) is known, and if the position C′ in original image 614(b) corresponding to the destination pixel C(x−1, y) of deformed image 610(b) is known, then the coordinates of source pixel A′ in original image 614(b) may be obtained from the known coordinates of source pixels B′ and C′, and the x, y coordinates of the deformed image 610(b) by using the following recursive pixel-location equations:
x′=fₓ((x−1),y)+f₁(x)+f₂(y)
y′=f_{y}(x,(y−1))+f₃(x)+f₄(y)
where “x” is the x-coordinate of a destination pixel of deformed image 610(b), “y” is the y-coordinate of the same destination pixel of deformed image 610(b), and f₁, f₂, f₃, and f₄ are offset functions corresponding to a particular deformation effect.

The foregoing recursive pixel-location equations are true for many different deformation effects. With these recursive pixel-location equations, if the y′ coordinates (the value: yᵢ₀′) of the source pixels in the first horizontal line of the original image 614(b) are known, and if the x′ coordinates (the value x₀ⱼ′) of the source pixels in the first vertical row of original image 614(b) are know, and if the offset functions, f₁, f₂, f₃ and f₄ are known, then display controller 128 may calculate the x′ and y′ coordinates for each source pixel from original image 614(b) for populating corresponding destination pixels in deformed image 610(b), by using four adders and the foregoing two recursive pixel-location equations.

In the FIG. 7 embodiment, the specific equation variables, x₀ⱼ′, yᵢ₀′, f₁(x), f₂(y), f₃(x), and f₄(y), depend on the particular deformation effect being performed. These equation variables only need to be calculated once, and may then be stored in relatively small deformation lookup tables 228. During the foregoing calculations, a small y_{old}′ lookup table 228 is utilized to store y′ coordinates from an immediately-preceding line in original image 610(b). Similarly, a cₓ′ buffer may be provided in lookup table 228 for storing an x′ coordinate for an immediately-preceding pixel in original image 614(b).

In accordance with the FIG. 7 embodiment, a lookup table 228 for a given deformation effect may therefore be efficiently implemented as follows:
x₀ⱼ′: VDP entries
   (every entry needs 2 bytes, so its size=VDP*2 bytes)
yᵢ₀′: HDP entries
   (every entry needs 2 bytes, so its size=HDP*2 bytes)
f₁(x): HDP entries
   (every entry needs 2 bytes, so its size=HDP*2 bytes)
f₂(y): VDP entries
   (every entry needs 2 bytes, so its size=VDP*2 bytes)
f₃(x): HDP entries
   (every entry needs 2 bytes, so its size=HDP*2 bytes)
f₄(y): VDP entries
   (every entry needs 2 bytes, so its size=VDP*2 bytes)
y_{old}′: HDP entries
   (every entry needs 3 bytes to keep accuracy, so its size=HDP*3 bytes)
cₓ′: 1 entry (its size=3 bytes)
   A compact lookup table 228 may thus be efficiently implemented with a total storage requirement of: HDP*9+VDP*6+3. For a 1280 pixel×1024 pixel image, the total storage requirement is therefore only 1280*9+1024*6+3=17,667 Bytes.

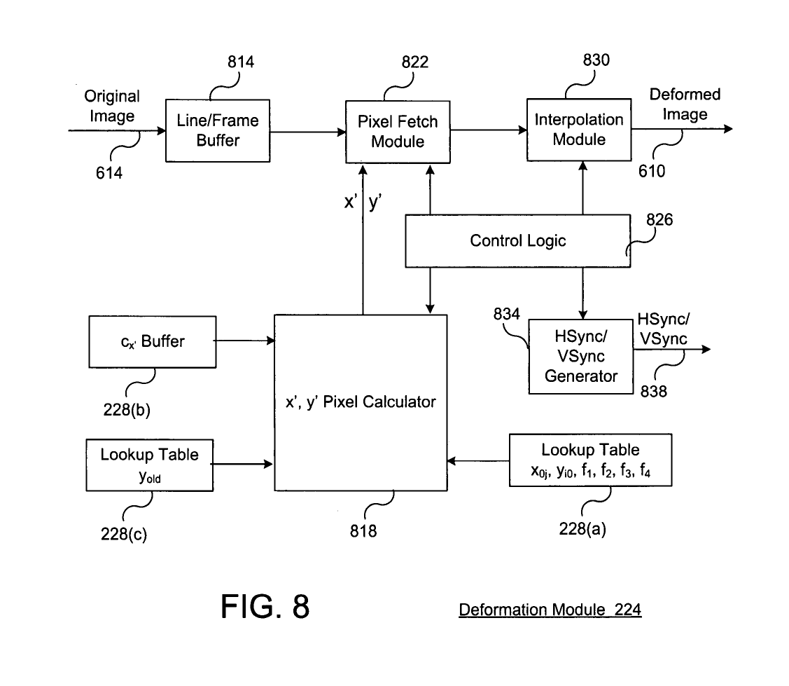

Referring now to FIG. 8, a block diagram for one embodiment of the FIG. 2 deformation module 224 is shown, in accordance with the present invention. In alternate embodiments, the present invention may efficiently support deformation procedures by utilizing components, configurations, and techniques in addition to, or instead of, certain of those components, configurations and techniques shown in the FIG. 8 embodiment.

In the FIG. 8 embodiment, image data from an original image 614 is initially stored in a line/frame buffer 814. Pixel calculator 818, under control of control logic 826, then calculates the x′ and y′ coordinates of source pixels in original image 614 by referencing precalculated information in deformation lookup table 228 (FIG. 2). In the FIG. 8 embodiment, pixel calculator 818 may utilize the recursive pixel-location equations discussed above in conjunction with FIG. 7. In the FIG. 8 embodiment, the precalculated information that pixel calculator 818 accesses from lookup table 228 may include x₀ⱼ, yᵢ₀, f₁, f₂, f₃, and f₄ from lookup table 228(a), y_{old} from lookup table 228(c), and cₓ from a lookup table buffer 228(b).

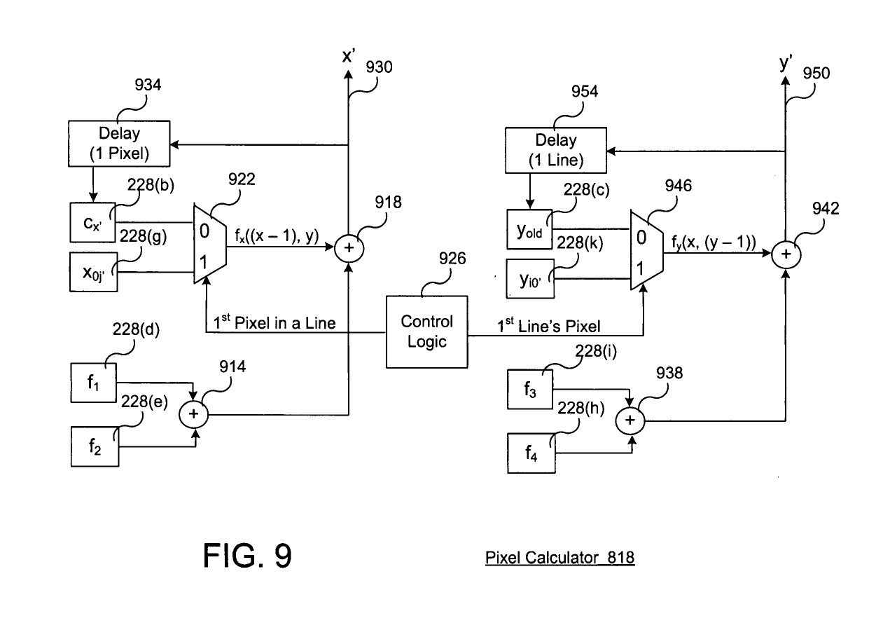

In the FIG. 8 embodiment, a pixel fetch module 822, under control of control logic 826, utilizes the calculated x′ and y′ coordinates to locate appropriate source pixels in original image 614 for populating a deformed image 610. In the FIG. 8 embodiment, an interpolation module 830 utilizes the identified x′ and y′ coordinates of the source pixels for performing an interpolation procedure with neighboring pixels from original image 614 to produce final destination pixels for deformed image 610, as discussed above in conjunction with FIG. 6. In the FIG. 8 embodiment, control logic 826 also utilizes HSync/VSync generator 834 to produce an HSync/VSync signal 838. One implementation for pixel calculator 818 is further discussed below in conjunction with FIG. 9.

Referring now to FIG. 9, a block diagram for one embodiment of the FIG. 8 pixel calculator 818 is shown, in accordance with the present invention. In alternate embodiments, the present invention may efficiently support deformation procedures by utilizing components, configurations, and techniques in addition to, or instead of, certain of those components, configurations and techniques shown in the FIG. 9 embodiment.

In the FIG. 9 embodiment, in order to calculate an x′ coordinate for a source pixel from original image 614 in accordance with an x′ recursive pixel-location equation (as discussed above in conjunction with FIG. 7), an adder 914 adds an f₁ offset function value 228(d) and an f₂ offset function value 228(e) that are retrieved from lookup table 228 (FIG. 2) to produce an x′ offset sum value. Adder 914 then provides the x′ offset sum value to adder 918.

In the FIG. 9 embodiment, adder 918 adds the x′ offset sum value from adder 914 to an x′ function value (fₓ((x−1),y)) from multiplexer 922 to produce the x′ coordinate of a source pixel from original image 614. Adder 918 may then provide the x′ coordinate for the current source pixel to pixel fetch module 822 (FIG. 8) via path 930. In the FIG. 9 embodiment, adder 918 may also provide the calculated x′ coordinate to a delay (1 pixel) module 934 that delays the calculated x′ coordinate by one pixel to produce a cₓ′ value 228(b) that is stored into an appropriate location in lookup table 228 (FIG. 2).

In the FIG. 9 embodiment, control logic 926 controls the output of multiplexer 922. In particular, at the first pixel in a display line, control logic 926 provides an x₀ⱼ′ value 228(g) from lookup table 228 for calculating the foregoing x′ function value. In all other instances, control logic 926 provides the cₓ′ value 228(b) from lookup table 228 for calculating the x′ function value.

In the FIG. 9 embodiment, in order to calculate a y′ coordinate for a source pixel from original image 614 in accordance with a y′ recursive pixel-location equation (as discussed above in conjunction with FIG. 7), an adder 938 adds an f₃ offset function value 228(i) and an f₄ offset function value 228(h) that are retrieved from lookup table 228 (FIG. 2) to produce a y′ offset sum value. Adder 938 then provides the y′ offset sum value to adder 942.

In the FIG. 9 embodiment, adder 942 adds the y′ offset sum value from adder 938 to a y′ function value (f_{y}(x,(y−1)) from multiplexer 946 to produce the y′ coordinate of a source pixel from original image 614. Adder 942 may then provide the y′ coordinate for the current source pixel to pixel fetch module 822 via path 950. In the FIG. 9 embodiment, adder 942 may also provide the calculated y′ coordinate to a delay (1 line) module 954 that delays calculated y′ coordinate by one display line to produce a y_{old} value 228(c) that is stored into an appropriate location in lookup table 228 (FIG. 2).

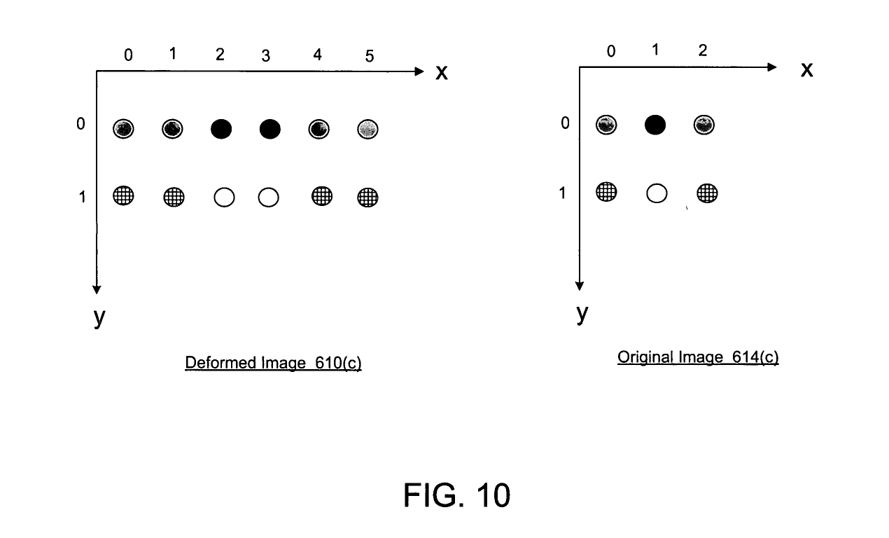

In the FIG. 9 embodiment, control logic 926 controls the output of multiplexer 946. In particular, during the first display line, control logic 926 provides a yᵢ₀′ value 228(k) from lookup table 228 for calculating the foregoing y′ function value. In all other instances, control logic 926 provides the y_{old} value 228(c) from lookup table 228 for calculating the y′ function value. The utilization of pixel calculator 818 is further discussed below in conjunction with FIGS. 10-12.

Referring now to FIG. 10, a diagram illustrating one exemplary embodiment of a horizontal 2X zoom deformation is shown, in accordance with the present invention. The example shown in FIG. 10 is presented for purposes of illustration, and in alternate embodiments, the present invention may efficiently support various zoom deformation procedures by utilizing configurations and techniques in addition to, or instead of, certain of those configurations and techniques shown in the FIG. 10 embodiment.

In accordance with one embodiment of the present invention, a zoom deformation procedure may be performed for zooming from the left-top corner of display 134 (FIG. 1) according to the following basic zoom formulas:
y′=Z_{y}*y
x′=Zₓ*x
where Zₓ and Z_{y} are respective zoom ratios in the x and y directions. If Z is greater than 1, then the zoom deformation procedure is a zoom-in procedure. Alternately, if Z is greater than zero but less than 1, the zoom deformation procedure is a zoom-out procedure.

The present invention may map the foregoing basic zoom formulas to the recursive pixel-location equations discussed above in conjunction with FIG. 7 (x′=fₓ((x−1),y)+f₁(x)+f₂(y) and y′=f_{y}(x,(y−1))+f₃(x)+f₄(y)). Referring again to FIG. 7, let us assume that the coordinates for the three destination pixels (A, B, and C) in the FIG. 7 embodiment may be expressed with the following destination coordinates:
A: (Aₓ, A_{y})
B: (Bₓ, B_{y})
C: (Cₓ, C_{y})
In the FIG. 7 example, destination pixel B is one line above the destination pixel A. In addition, destination pixel C is one pixel to left of destination pixel A. Therefore, the coordinates of destination pixel A may be expressed by the following formulas:
Aₓ=Bₓ
Aₓ=Cₓ+1
A_{y}=B_{y}+1
A_{y}=C_{y}
In a zoomed (deformed) image, the three destination pixel locations may be expressed by the following formulas:
A′: (Aₓ′, A_{y}′)
B′: (Bₓ′, B_{y}′)
C′: (Cₓ′, C_{y}′)
Therefore, according to the foregoing basic zoom formulas, the coordinates of destination pixel A′ may be expressed by the following formulas:

$$\begin{matrix}{A}_{x}^{′} = {Z}_{x} * {A}_{x} \\ = {Z}_{x} * ( {C}_{x} + 1 ) \\ = {Z}_{x} * {C}_{x} + {Z}_{x}\end{matrix}$$

$$\begin{matrix}{A}_{y}^{′} = {Z}_{y} * {A}_{y} \\ = {Z}_{y} * ( {B}_{y} + 1 ) \\ = {Z}_{y} * {B}_{y} + {Z}_{y}\end{matrix}$$

If we let Ax=x, and let Ay=y, then the other variables in the recursive pixel-location equations of FIG. 7 may be expressed by the following formulas:
x₀ⱼ′=fₓ(0,j)=0
yᵢ₀′=f_{y}(i,0)=0
f₁(x)=Zₓ
f₂(y)=0
f₃(x)=0
f₄(y)=Z_{y}

Referring again to FIG. 10, the horizontal 2× zoom deformation may be performed according to the following basic 2× zoom formulas:
X′=X/2
Y′=Y
where X′ and Y′ are coordinates of source pixels from original image 614(c), and X and Y are coordinates of destination pixels from deformed image 610(c). If the 2× deformed image is scanned from left-to-right, and top-to-bottom, then
the first destination pixel D(0, 0) in 2× deformed image 610(c) comes from source pixel S(0, 0) in original image 614(c). According to the foregoing basic 2× zoom formulas, destination pixels, D(x, y), may therefore be mapped to corresponding source pixels, S(x′, y′), according to the following sequences:
D(0, 0)→S(0, 0), D(1, 0)→S(0.5, 0), D(2,0)→S(1, 0), etc., up to D(6,0)→S(3, 0)
D(0, 1)→S(0, 1), D(1, 1)→S(0.5, 1), D(2,1)→S(1, 1), etc., up to D(6,0)→S(3, 1)

In certain embodiments of the present invention, instead of utilizing the recursive pixel-location formulas of FIG. 7 to locate all source pixels, one or more offset values may be sequentially applied to successive source pixel coordinates to calculate succeeding source pixel coordinates. For example, in the FIG. 10 example, if the FIG. 7 recursive pixel-location equations are not utilized to calculate all X′ and Y′ coordinates of source pixels in original image 614(c), then the X coordinate of a given current source pixel may be calculated by adding an offset value to the X′ coordinate of the prior adjacent source pixel that immediately precedes a succeeding source pixel.

In the 2× zoom deformation example, if we know that a destination pixel D(4, 0) corresponds to a source pixel S(2, 0), then it may be determined that the next destination pixel D(5, 0) corresponds to source pixel S((2+0.5), 0)=S(2.5, 0) by adding an offset value of 0.5 to the X′ coordinate of prior source pixel S(2, 0). Therefore, in the FIG. 10 example, the offset value is equal to 0.5.

In order to obtain the location of a source pixel in original image 614(c) for destination pixel D(4, 0), the position of the source pixel for destination pixel D(3,0) must be know, and so on. Ultimately, the position of the source pixel corresponding to the top left destination pixel D(0, 0) must be known. In the other word, if the location of the original source pixel corresponding to the top left destination pixel D(0, 0) is known, then, in the FIG. 10 example, the offset value of 0.5 may be sequentially added to the X′ coordinate of a given current pixel to locate each succeeding source pixel.

In accordance with this technique, the FIG. 7 recursive pixel-location equations need only be utilized to calculate the source pixel from original image 614(c) that corresponds to the top left destination pixel D(0, 0) in deformed image 610(c). After the source pixel corresponding to top left destination pixel is determined, a simple sequential addition procedure may efficiently be utilized to locate all remaining source pixels in the original image for populating deformed image 610(c).

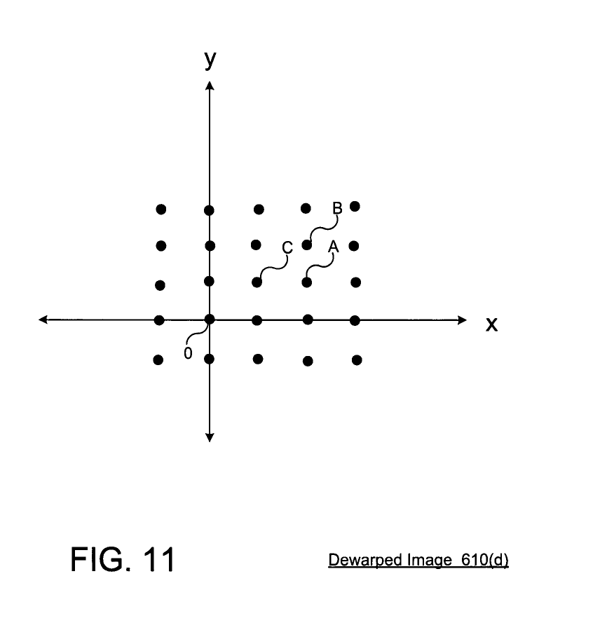

Referring now to FIG. 11, a diagram illustrating one exemplary embodiment of a dewarped image 610(d) is shown, in accordance with the present invention. The example shown in FIG. 11 is presented for purposes of illustration, and in alternate embodiments, the present invention may efficiently support various dewarping deformation procedures by utilizing configurations and techniques in addition to, or instead of, certain of those configurations and techniques shown in the FIG. 11 embodiment.

Warping of an image is an effect seen in images captured with low-cost camera lenses whereby the edges of the image are curved in either an inward, pin-cushion warping effect, or in an outward, barrel warping effect. In certain embodiments, a dewarping deformation algorithm may be utilized to reverse the lens effect in accordance with the following basic dewarping formulas:
Y′=Y+k_{y}R²Y
X′=X+kₓR²X
where coordinates (X′, Y′) are the warped source pixel locations (normalized) in the original image, coordinates (X, Y) are the corrected destination pixel locations (normalized) in the deformed image 610(d), R²=X²+Y² (normalized), and k_{y}, kₓ are distortion coefficients determined by the lens characterization process, and depends on the particular lens. Negative k values are for barrel effects and positive k values are for pin cushion effects. Normally, |k|<0.1.

In the FIG. 11 example, if we set the central destination pixel's position to be at coordinate (0, 0), then the top-left destination pixel's position is at coordinates (−h, −v), where h=HDP/2, and v=VDP/2. For a source pixel (x, y), the normalized position (X, Y) may be expressed by the following formulas:
X=x/h
Y=y/v
In order to obtain the (x′, y′) coordinates of a source pixel from the normalized (X′, Y′), the following formulas may be utilized:
x′=X′*h
y′=Y′*v

In the FIG. 11 example, let us assume the coordinates of the three destination pixels in dewarped image 610(d) may be expressed as follows:
A: (Aₓ, A_{y})
B: (Bₓ, B_{y})
C: (Cₓ, C_{y})

In the FIG. 11 example, destination pixel B is one line above destination pixel A. In addition, destination pixel C is one pixel to the left of destination pixel A. Therefore, the coordinates of destination A may be expressed by the following equations:
Aₓ=Bₓ
Aₓ=Cₓ+1
A_{y}=B_{y}+1
A_{y}=C_{y}
In the warped original image, the three corresponding source pixel locations may be expressed as follows:
A′: (Aₓ′, A_{y}′)
B′: (Bₓ′, B_{y}′)
C′: (Cₓ′, C_{y}′)

In order to calculate coordinates (Aₓ′, A_{y}′) for source pixels from the original warped image, let us assume that the whole image size is HDP * VDP, and that the top-left coordinates are (−h, −v), where h=HDP/2, and v=VDP/2. Then, the Aₓ′ coordinates for source pixels may be calculated according to the following formulas:

$${R}^{ 2} = {( {A}_{ x} / h )}^{2} + {( {A}_{ y} / v )}^{2}$$

$$\begin{matrix} {A}_{ x}^{ ′} = {A}_{ x} + {k}_{ x} * {R}^{ 2} {A}_{ x} \\ = ( {C}_{ x} + 1 ) + {k}_{ x} * [ {( ( {C}_{ x} + 1 ) / h )}^{2} + {( {C}_{ y} / v )}^{2} ] ( {C}_{ x} + 1 ) \\ = {C}_{ x} + {k}_{ x} * [ {( {C}_{ x} / h )}^{2} + {( {C}_{ y} / v )}^{2} ] {C}_{ x} + 1 + {k}_{ x} * \\ [ ( ( 2 {C}_{ x} + 1 ) / {h}^{ 2} ] \\ {C}_{ x} + {k}_{ x} * [ {( ( {C}_{ x} + 1 ) / h )}^{2} + {( {C}_{ y} / v )}^{2} ] \\ = {C}_{ x}^{ ′} + 1 + {k}_{ x} * [ ( ( 2 {C}_{ x} + 1 ) / {h}^{ 2} ] {C}_{ x} + {k}_{ x} * \\ [ {( ( {C}_{ x} + 1 ) / h )}^{2} + {( {C}_{ y} / v )}^{2} ] \\ = {C}_{ x}^{ ′} + 13 {k}_{ x} * ( {C}_{ x}^{ 2} + {C}_{ x} ) / {h}^{ 2} + {k}_{ x} * {C}_{ y}^{ 2} / {v}^{ 2} + {k}_{ x} / {h}^{ 2} \\ = {C}_{ x}^{ ′} + 1 + 3 {k}_{ x} * ( {C}_{ x}^{ 2} + {C}_{ x} ) / {h}^{ 2} + {k}_{ x} * {A}_{ y}^{ 2} / {v}^{ 2}\end{matrix}$$

In certain embodiments, kₓ/h² is very small (for example, in a 320×240 image, kₓ=0.1, and kₓ/h²=0.1/1602=3.9×10⁻⁶. In certain embodiments, kₓ/h² may thus be ignored.

Calculating the A_{y}′ coordinates for source pixels may be similarly performed according to the following formulas:

$$\begin{matrix} {A}_{ y}^{ ′} = {A}_{ y} + {k}_{ y} * {R}^{ 2} {A}_{ y} \\ = ( {B}_{ y} + 1 ) + {k}_{ y} * [ {( {B}_{ x} / h )}^{2} + {( ( {B}_{ y} + 1 ) / v )}^{2} ] \\ ( {B}_{ y} + 1 ) \\ = {B}_{ y} + {k}_{ y} * [ {( {B}_{ x} / h )}^{2} + {( {B}_{ y} / v )}^{2} ] {B}_{ y} + 1 + {k}_{ y} * \\ [ ( ( 2 {B}_{ y} + 1 ) / {v}^{ 2} ] {B}_{ y} + {k}_{ y} * \\ [ {( {B}_{ x} / h )}^{2} + {( ( {B}_{ y} + 1 ) / v )}^{2} ] \\ = {B}_{ y}^{ ′} + 1 + {k}_{ y} * [ ( ( 2 {B}_{ y} + 1 ) / {v}^{ 2} ] + {B}_{ y} + {k}_{ y} * \\ [ {( {B}_{ x} / h )}^{2} + {( ( {B}_{ y} + 1 ) / v )}^{2} ] \\ = {B}_{ y}^{ ′} + 1 + 3 {k}_{ y} * ( {B}_{ y}^{ 2} + {B}_{ y} ) / {v}^{ 2} + {k}_{ y} * \\ {B}_{ x}^{ 2} / {h}^{ 2} + {k}_{ y} / {v}^{ 2} \\ = {B}_{ y}^{ ′} + 1 + 3 {k}_{ y} * ( {B}_{ y}^{ 2} + {B}_{ y} ) / {v}^{ 2} + {k}_{ y} * {A}_{ x}^{ 2} / {h}^{ 2}\end{matrix}$$

In certain embodiments, k_{y}/v² is very small (for example, in a 320×240 image, k_{y}=0.1, and k_{y}/v²=0.1/1602=3.9×10⁻⁶. In certain embodiments, k_{y}/v² may thus be ignored.)

In the FIG. 11 dewarping example, if we let Aₓ=x, and let A_{y}=y, then the other variables in the recursive pixel-location equations of FIG. 7 may be expressed by the following formulas:

$${x}_{0 j}^{′} = {f}_{x} ( \text{-} h , j ) \\ = \text{-} h \text{-} h * {{k}_{x} ( 1 + j / v )}^{2}$$

$$( j from - v to v - 1 ; for {x}_{0 j}^{′} , {A}_{x} = \text{-} h , {A}_{y} = j )$$

$${y}_{i0}^{′} = {f}_{y} ( i , - v ) \\ = \text{-} v - v * {{k}_{y} ( 1 + i / h )}^{2}$$

$$( i from \text{-} h to h - 1 ; for {y}_{i 0}^{′} , {A}_{x} = i , {A}_{y} = \text{-} v )$$

f₁(x)=3 kₓ*((x−1)²+(x−1))/h²
f₂(y)=kₓ*y²/v²
f₃(x)=k_{y}*x²/h²
f₄(y)=3 k_{y}*((y−1)²+(y−1))/v²
(−h<=x<h; −v<=y<v)
In certain embodiments, the FIG. 10 zoom deformation effect may be combined with the FIG. 11 dewarping deformation effect by adding the zoom-ratio of FIG. 10 into the f₁, f₂, f₃ and f₄ values.

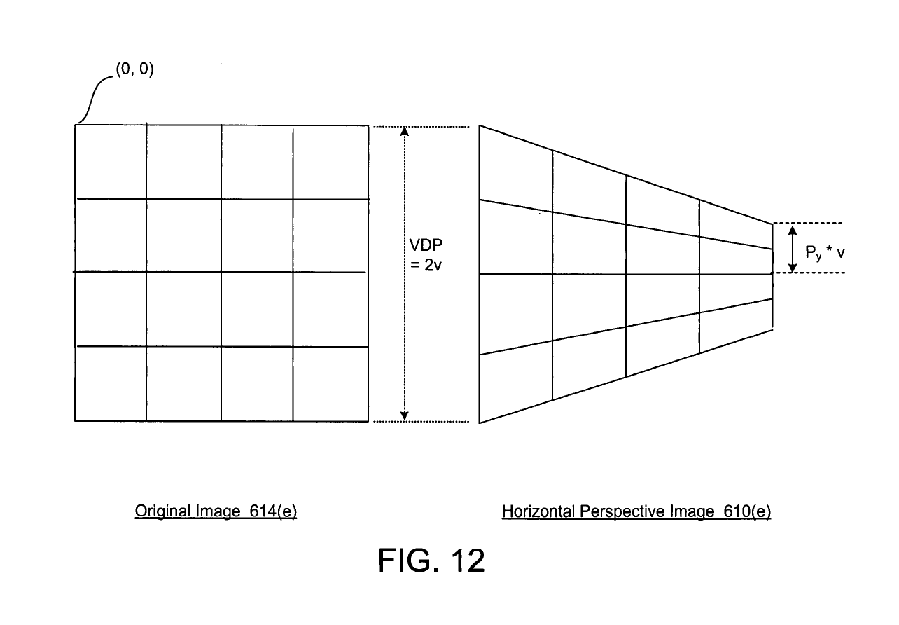

Referring now to FIG. 12, a diagram illustrating one exemplary embodiment of a horizontal perspective deformation is shown, in accordance with the present invention. The example shown in FIG. 12 is presented for purposes of illustration, and in alternate embodiments, the present invention may efficiently support various perspective deformation procedures by utilizing configurations and techniques in addition to, or instead of, certain of those configurations and techniques shown in the FIG. 12 embodiment.

In the FIG. 12 embodiment, x′ and y′ coordinates for source pixels in original image 614(e) may be calculated with the following basic perspective deformation formulas:
y′=v+2*(y−v)/[(1+P_{y})−(1−P_{y})*(x−h)/h]
x′=x
where v equals VDP/2, h equals HDP/2, x: 0˜HDP-1, y: 0˜VDP-1, and P_{y} is the perspective ratio.

When the foregoing perspective values are mapped to the FIG. 7 recursive pixel-location equations of x′=fₓ((x−1),y)+f₁(x)+f₂(y), and y′=f_{y}(x,(y−1))+f₃(x)+f₄(y), the following values are obtained:
x₀ⱼ′=fx(0,j)=0
yᵢ₀′=fy(i,0)=v−2v/[(1+P_{y})−(1−P_{y})*(i−h)/h]
f₁(x)=1
f₂(y)=0
f₃(x)=2/[(1+P_{y})−(1−P_{y})*(x−h)/h]
f₄(y)=0

The present invention may be utilized any appropriate deformation effects by implementing the recursive pixel-location equations of FIG. 7. Such deformation effects may include vertical perspective, zoom from the image center, and wave effects. The present invention provides an effective recursive method to support different image deformation effects with the same compact hardware in a display controller. For at least the foregoing reasons, the present invention provides an improved system and method for efficiently supporting image deformation procedures in an electronic device.

The invention has been explained above with reference to certain preferred embodiments. Other embodiments will be apparent to those skilled in the art in light of this disclosure. For example, the present invention may be implemented using certain configurations and techniques other than those described in the embodiments above. Additionally, the present invention may effectively be used in conjunction with systems other than those described above as the preferred embodiments. Therefore, these and other variations upon the foregoing embodiments are intended to be covered by the present invention, which is limited only by the appended claims.

What is claimed is:

1. A system for supporting an image deformation procedure in an electronic device, comprising:
a deformation lookup table, coupled to said electronic device, to store deformation values for performing said image deformation procedure; and
a deformation module that includes a pixel calculator which utilizes said deformation values from said deformation lookup table to calculate source pixel locations of source pixels in an original image for populating destination pixels in a deformed image.

2. The system of claim 1 wherein said deformation module is implemented in a display controller integrated-circuit device that functions as an interface between a central processing unit and a display device in a portable electronic device.

3. The system of claim 1 wherein said deformation module includes an interpolation module that performs interpolation procedures with neighboring pixels of said source pixels to obtain color data for said destination pixels.

4. The system of claim 1 wherein a central processing unit of said electronic device executes deformation software to initially calculate said deformation values for populating said deformation lookup table, said deformation values depending upon a deformation effect type of said deformation procedure.

5. The system of claim 1 wherein said deformation lookup table includes y′ coordinates of said source pixels in a first horizontal line of said original image, x′ coordinates of said source pixels in a first vertical row of said original image, offset function values f₁, f₂, f₃ and f₄, y′ coordinates from an immediately-preceding line in said original image, and an x′ coordinate for an immediately-preceding pixel in said original image.

6. The system of claim 1 wherein said pixel calculator calculates said source pixel locations by utilizing recursive pixels equations in conjunction with said deformation values from said deformation lookup table.

7. The system of claim 6 wherein said pixel calculator determines source pixel coordinates, x′, according to an x′ recursive pixel-location equation:
x=fₓ((x−1),y)+f₁(x)+f₂(y)
where said fₓ is an x deformation function, said x is an x-coordinate of one of said destination pixels of said deformed image, and said f₁ and said f₂ are x offset functions corresponding to said deformation procedure.

8. The system of claim 6 wherein said pixel calculator calculates source pixel coordinates, y′, according to a y′ recursive pixel-location equation:
y′=f_{y}(x,(y−1))+f₃(x)+f₄(y)
where said f_{y} is a y deformation function, said y is a y-coordinate of one of said destination pixels of said deformed image, and said f₃ and said f₄ are y offset functions corresponding to said deformation procedure.

9. The system of claim 6 wherein said pixel calculator utilizes said recursive pixel-location equations to locate a top left one of said source pixels, said pixel calculator then sequentially applying one or more deformation offset values to current ones of said source pixel locations to calculate succeeding ones of said source pixels locations.

10. The system of claim 1 wherein said deformation procedure supports a zoom effect in which said destination pixels of said deformed image are obtained from said source pixels of said original image by applying at least one of a horizontal zoom ratio and a vertical zoom ratio.

11. The system of claim 1 wherein said deformation procedure supports a horizontal 2× zoom effect, said pixel source calculator applying a deformation offset value of 0.5 to x coordinates of said source pixel locations to calculate succeeding ones of said source pixels locations.

12. The system of claim 1 wherein said deformation procedure supports an image dewarping effect in which said original image is distorted in a pin cushion effect or a barrel effect, said deformation procedure producing a dewarped final image from said original image.

13. The system of claim 12 wherein said original image is distorted by an image capture lens that fails to accurately capture an imaging target, said deformation procedure compensating for warping artifacts introduced by said image capture lens.

14. The system of claim 1 wherein said deformation procedure supports a perspective effect in which said destination pixels of said deformed image are obtained from said source pixels of said original image by applying at least one of a horizontal perspective ratio and a vertical perspective ratio.

15. The system of claim 1 wherein said deformation module includes a pixel fetch module that obtains said source pixels from said original image for populating corresponding ones of said destination pixels of said deformed image based upon x′ coordinates and y′ coordinates of said source pixels received from said pixel calculator.

16. The system of claim 1 wherein said pixel calculator is implemented as a compact hardware circuit that calculates x′ coordinates and y′ coordinates of said source pixel locations.

17. The system of claim 1 wherein said pixel calculator calculates x′ coordinates and y′ coordinates of said source pixel locations by utilizing four adders to perform recursive pixel-location equations.

18. The system of claim 1 wherein said pixel calculator includes control logic that controls an x multiplexer so that, at a first pixel in a display line, said x multiplexer transmits an x₀ⱼ value from said deformation lookup table for calculating an x′ coordinate, said control logic otherwise provides a cₓ, value from said deformation lookup table for calculating said x′ coordinate, said control logic also controlling a y multiplexer so that, during a first display line, said y multiplexer transmits a yᵢ₀, value from said deformation lookup table for calculating a y′ coordinate, said control logic otherwise providing a y_{old} value from said deformation lookup table for calculating said y′ coordinate.

19. A method for supporting an image deformation procedure in an electronic device, comprising the steps of:
utilizing a deformation lookup table to store deformation values for performing said image deformation procedure; and
implementing a deformation module that includes a pixel calculator which utilizes said deformation values from said deformation lookup table to calculate source pixel locations of source pixels in an original image for populating destination pixels in a deformed image.

20. A system for supporting an image deformation procedure in an electronic device, comprising:
a deformation lookup table to store deformation values for performing said image deformation procedure; and
a pixel calculator that references said deformation values to calculate source pixels for populating destination pixels in a deformed image.
